(19) United States
(12) Patent Application Publication
(10) Pub. No.: US 2013/0065016 A1
(43) Pub. Date: Mar. 14, 2013

(54) THERMAL CONDUCTIVE SHEET AND PRODUCING METHOD THEREOF

(71) Applicants: Seiji IZUTANI, Osaka (JP); Takahiro FUKUOKA, Osaka (JP); Kunio NAGASAKI, Osaka (JP); Yusuke SUGINO, Osaka (JP); Kohei DOI, Osaka (JP)

(72) Inventors: Seiji IZUTANI, Osaka (JP); Takahiro FUKUOKA, Osaka (JP); Kunio NAGASAKI, Osaka (JP); Yusuke SUGINO, Osaka (JP); Kohei DOI, Osaka (JP)

(73) Assignee: NITTO DENKO CORPORATION, Osaka (JP)

(21) Appl. No.: 13/607,068

(22) Filed: Sep. 7, 2012

(30) Foreign Application Priority Data
Sep. 9, 2011 (JP) 2011-197525

(51) Int. Cl. B32B 3/22; B32B 38/04; B32B 37/26

(52) U.S. Cl. 428/120; 156/250

(57) ABSTRACT

A thermal conductive sheet is obtained by preparing a resin layer; laminating a particle-containing monomer mixture layer which contains a monomer to be absorbed in the resin layer and a thermal conductive particle on one side surface of the resin layer; localizing the thermal conductive particle at one surface side by allowing the monomer to be absorbed in the resin layer; thereafter, reacting the monomer to be cured so as to fabricate a particle-localized sheet; laminating a plurality of the particle-localized sheets so as to allow one surface to be in contact with the other surface to fabricate a particle-localized sheet laminate; and then, cutting the particle-localized sheet laminate into a sheet shape along a laminating direction of each of the particle-localized sheets.

### CROSS-REFERENCE TO RELATED APPLICATION

The present application claims priority from Japanese Patent Application No. 2011-197525 filed on Sep. 9, 2011, the contents of which are hereby incorporated by reference into this application.

### BACKGROUND OF THE INVENTION

1. Field of the Invention

The present invention relates to a thermal conductive sheet, to be specific, to a thermal conductive sheet used as a heat dissipating material of various devices and a producing method thereof.

2. Description of Related Art

In hybrid devices, high-brightness LED devices, and electromagnetic induction heating devices, high electric power is converted to motive power, light, heat, and the like. With the miniaturization of the devices, a high electric current flows in a small area, so that the amount of heat generated per unit volume increases. Therefore, the above-described devices are required to have a heat dissipating material having a high heat resistance and thermal conductivity.

As the above-described heat dissipating material, an organic-inorganic composite material in which a filler having an excellent thermal conductivity such as alumina, silica, silicon nitride, boron nitride, aluminum nitride, and a metal particle is mixed in a resin material has been known for power electronics.

For example, it has been proposed that a sealing material is prepared by allowing an inorganic powder which contains a spherical alumina powder and a spherical silica powder that is finer than the spherical alumina powder and has a larger average sphericity than that of the spherical alumina powder to be filled in an epoxy resin composition (ref: for example, Japanese Unexamined Patent Publication No. 2003-306594).

In the sealing material, the filling rate is improved by embedding a small particle between particles and in this way, the improvement in thermal conductivity is achieved.

### SUMMARY OF THE INVENTION

However, in the above-described Japanese Unexamined Patent Publication No. 2003-306594, in order to further improve the thermal conductivity, a larger amount of the inorganic powder is required to be filled in the epoxy resin composition.

However, when a large amount of the inorganic powder is dispersed in the epoxy resin composition, there may be a case where properties such as a mechanical strength of the epoxy resin composition are reduced or the cost increases.

Also, there is a limit in mixing proportion of the inorganic powder capable of being dispersed in the epoxy resin composition.

It is an object of the present invention to provide a thermal conductive sheet which is capable of improving the thermal conductivity without increasing the used amount of a thermal conductive particle and a producing method thereof.

A thermal conductive sheet of the present invention is obtained by preparing a resin layer; laminating a particle-containing monomer mixture layer which contains a monomer to be absorbed in the resin layer and a thermal conductive particle on one side surface of the resin layer; localizing the thermal conductive particle at one surface side by allowing the monomer to be absorbed in the resin layer; thereafter, reacting the monomer to be cured so as to fabricate a particle-localized sheet; laminating a plurality of the particle-localized sheets so as to allow one surface thereof to be in contact with the other surface thereof to fabricate a particle-localized sheet laminate; and then, cutting the particle-localized sheet laminate into a sheet shape along a laminating direction of each of the particle-localized sheets.

A method for producing a thermal conductive sheet of the present invention includes the steps of preparing a resin layer, laminating a particle-containing monomer mixture layer which contains a monomer to be absorbed in the resin layer and a thermal conductive particle on one side surface of the resin layer, localizing the thermal conductive particle at one surface side by allowing the monomer to be absorbed in the resin layer, fabricating a particle-localized sheet by reacting the monomer to be cured, laminating a plurality of the particle-localized sheets so as to allow one surface thereof to be in contact with the other surface thereof to fabricate a particle-localized sheet laminate, and cutting the particle-localized sheet laminate into a sheet shape along a laminating direction of each of the particle-localized sheets.

According to the method for producing a thermal conductive sheet of the present invention, first, the particle-localized sheet in which the thermal conductive particles are localized at one side is fabricated.

Therefore, in the particle-localized sheet, the heat dissipating properties can be improved at one side surface in which the thermal conductive particles are localized.

A plurality of the particle-localized sheets are laminated so as to allow one surface thereof to be in contact with the other surface thereof, so that the particle-localized sheet laminate is fabricated.

That is, in the particle-localized sheet laminate, the thermal conductive particles are periodically localized in the laminating direction of the particle-localized sheet and are filled in a direction perpendicular to the laminating direction.

Thereafter, the particle-localized sheet laminate is cut into a sheet shape along the laminating direction, so that the thermal conductive sheet extending along the laminating direction is formed.

Therefore, in the thermal conductive sheet of the present invention, the thermal conductive particles are periodically localized in the plane direction (the direction in which the thermal conductive sheet extends, the same direction as the laminating direction) and are filled in the thickness direction (the direction perpendicular to the plane direction).

As a result, the thermal conductive particles are filled in the thickness direction and are periodically localized along the plane direction without increasing the used amount of the thermal conductive particles, so that the thermal conductivity in the thickness direction can be improved.

### BRIEF DESCRIPTION OF THE DRAWINGS

FIG. 1 shows a sectional view for illustrating one embodiment of a thermal conductive sheet of the present invention.

FIG. 2 shows explanatory views for illustrating a method for producing the thermal conductive sheet shown in FIG. 1:

(a) illustrating a step of applying a particle-containing monomer mixture to a separator,

(b) illustrating a step of laminating a particle-containing monomer mixture film and a resin layer,

(c) illustrating a step of localizing thermal conductive particles in the particle-containing monomer mixture, and

(d) illustrating a step of reacting a monomer to fabricate a particle-localized sheet.

FIG. 3 shows explanatory views for illustrating a method for producing the thermal conductive sheet shown in FIG. 1, subsequent to FIG. 2:

(a) illustrating a step of laminating a plurality of the particle-localized sheets to fabricate a particle-localized sheet laminate and

(b) illustrating a step of cutting the particle-localized sheet laminate into a sheet shape to form the thermal conductive sheet.

### DETAILED DESCRIPTION OF THE INVENTION

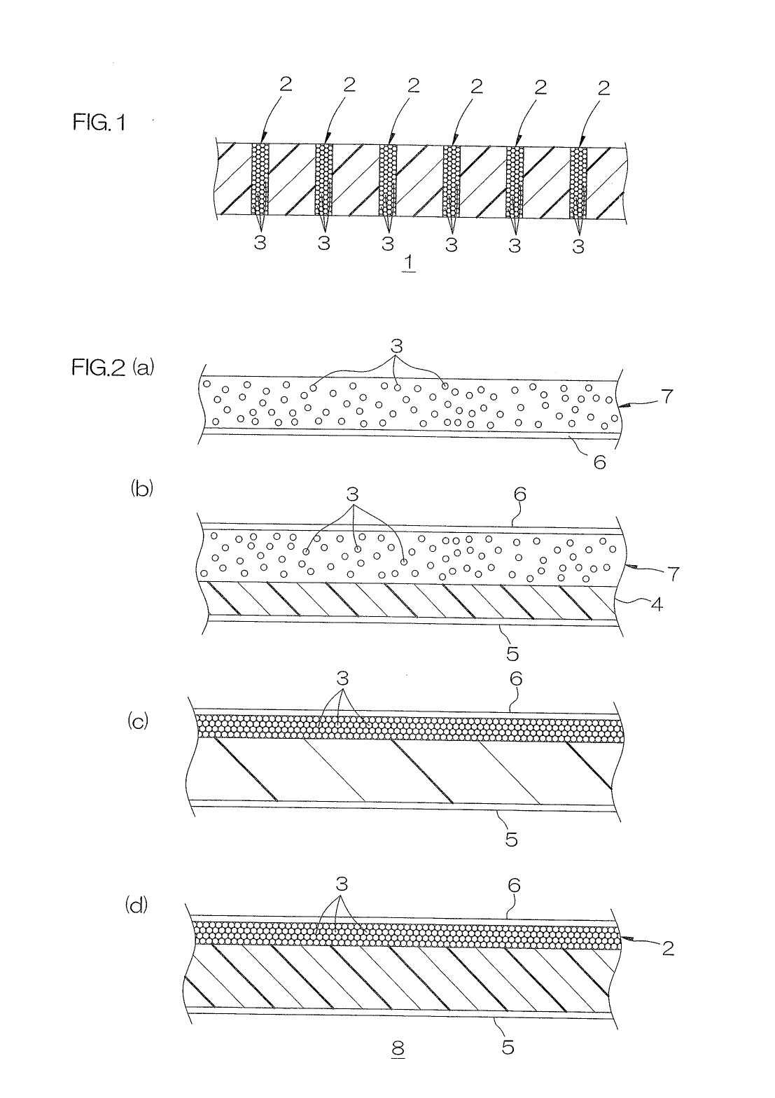

FIG. 1 shows a sectional view for illustrating one embodiment of a thermal conductive sheet of the present invention.

As shown in FIG. 1, a thermal conductive sheet 1 is a sheet which is formed from a resin, has a predetermined thickness, and extends in a direction perpendicular to the thickness direction. A plurality of particle filled layers 2 are formed in the thermal conductive sheet 1.

An example of the resin for forming the thermal conductive sheet 1 includes an acrylic resin.

The particle filled layer 2 is formed into a streak shape so as to penetrate through the thermal conductive sheet 1 along the thickness direction thereof. The particle filled layers 2 are periodically arranged at almost equal intervals with each other along the plane direction of the thermal conductive sheet 1. Thermal conductive particles 3 are filled in the particle filled layer 2.

Examples of the thermal conductive particle 3 include carbide, nitride, oxide, a metal, and a carbonaceous material.

Examples of the carbide include silicon carbide, boron carbide, aluminum carbide, titanium carbide, and tungsten carbide.

Examples of the nitride include silicon nitride, boron nitride, aluminum nitride, gallium nitride, chromium nitride, tungsten nitride, magnesium nitride, molybdenum nitride, and lithium nitride.

Examples of the oxide include silicon oxide (silica), aluminum oxide (alumina), magnesium oxide (magnesia), titanium oxide, and cerium oxide. Furthermore, examples of the oxide also include indium tin oxide and antimony tin oxide obtained by doping a metal ion thereto.

Examples of the metal include copper, gold, nickel, tin, iron, or alloys thereof.

Examples of the carbonaceous material include carbon black, graphite, and diamond.

The thermal conductive particles 3 can be used alone or in combination of two or more. Preferably, carbide, nitride, and oxide are used.

The average particle size of the thermal conductive particle 3 is, for example, 0.1 to 100 μm, or preferably 1 to 10 μm.

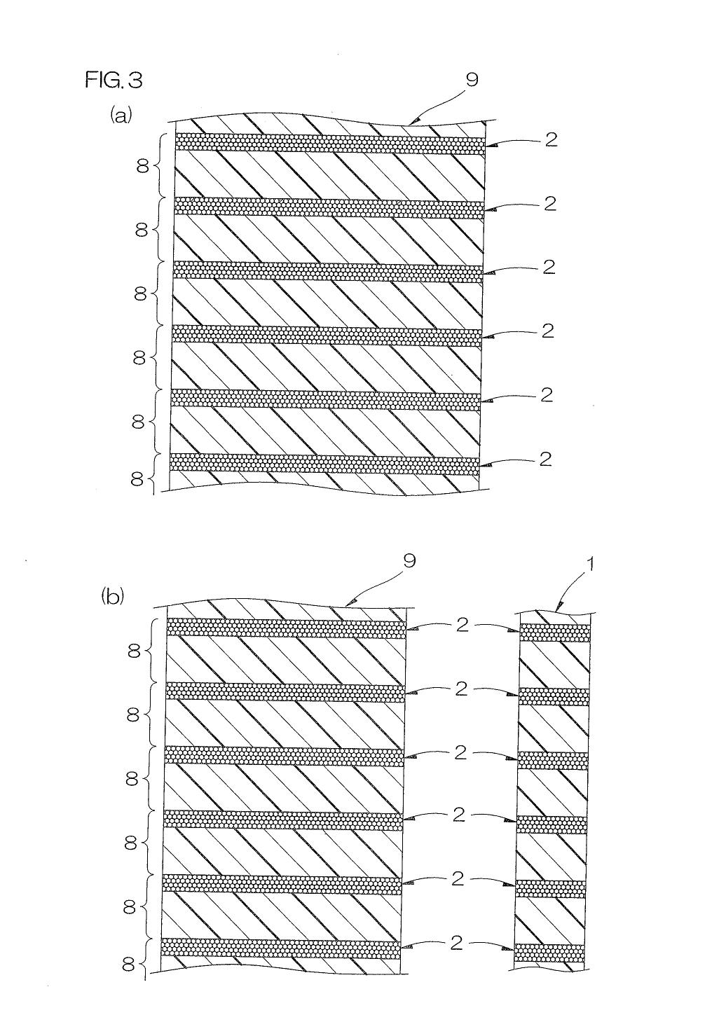

FIG. 2 shows explanatory views for illustrating a method for producing the thermal conductive sheet shown in FIG. 1: (a) illustrating a step of applying a particle-containing monomer mixture to a separator, (b) illustrating a step of laminating a particle-containing monomer mixture film and a resin layer, (c) illustrating a step of localizing thermal conductive particles in the particle-containing monomer mixture, and (d) illustrating a step of reacting a monomer to fabricate a particle-localized sheet. FIG. 3 shows explanatory views for illustrating a method for producing the thermal conductive sheet shown in FIG. 1, subsequent to FIG. 2: (a) illustrating a step of laminating a plurality of the particle-localized sheets to fabricate a particle-localized sheet laminate and (b) illustrating a step of cutting the particle-localized sheet laminate into a sheet shape to form the thermal conductive sheet.

Next, the method for producing the thermal conductive sheet 1 is described.

In this method, first, a particle-containing monomer mixture which contains the thermal conductive particles 3 and a monomer is prepared.

To prepare the particle-containing monomer mixture, first, the monomer is partially polymerized, so that a monomer composition (syrup) in which the monomer and the polymer are mixed is prepared.

An example of the monomer includes a monomer which is capable of preparing the above-described resin by polymerization. In the case of an acrylic resin, examples thereof include a (meth)acrylic acid ester monomer, a functional group-containing unsaturated monomer, and a polyfunctional unsaturated monomer.

An example of the (meth)acrylic acid ester monomer includes alkyl (meth)acrylate (alkyl methacrylate or alkyl acrylate) containing an alkyl group having 1 to 18 carbon atoms. To be specific, examples of the (meth)acrylic acid ester monomer include methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, t-butyl (meth)acrylate, pentyl (meth)acrylate, neopentyl (meth)acrylate, isoamyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, and 2-ethylhexadecyl (meth)acrylate. Preferably, 2-ethylhexyl (meth)acrylate is used. The (meth)acrylic acid ester monomers can be used alone or in combination of two or more.

Examples of the functional group-containing unsaturated monomer include a carboxyl group-containing monomer such as acrylic acid, methacrylic acid, fumaric acid, maleic acid, crotonic acid, carboxyethyl (meth)acrylate, vinyl acetate, and vinyl propionate; a hydroxyl group-containing monomer such as 2-hydroxyethyl acrylate, 2-hydroxypropyl acrylate, and 2-hydroxybutyl acrylate; an amide group-containing monomer such as (meth)acrylamide, N,N-dimethyl (meth)acrylamide, N,N-diethyl (meth)acrylamide, N-isopropyl (meth)acrylamide, N-butyl (meth)acrylamide, N-methoxymethyl (meth)acrylamide, N-methylol (meth)acrylamide, N-methylolpropane (meth)acrylamide, and N-vinylcarboxylic amide; an amino group-containing monomer such as aminoethyl (meth)acrylate, N,N-dimethylaminoethyl (meth)acrylate, and t-butylaminoethyl (meth)acrylate; a glycidyl group-containing monomer such as glycidyl (meth)acrylate and methylglycidyl (meth)acrylate; a cyano group-containing monomer such as acrylonitrile and methacrylonitrile; an isocyanate group-containing monomer such as 2-methacryloyloxyethylisocyanate; a sulfo group-containing monomer such as styrenesulfonic acid, allylsulfonic acid, 2-(meth)acrylamide-2-methylpropanesulfonate, (meth)acrylamidepropanesulfonate, sulfopropyl(meth)acrylate, and (meth)acryloyloxynaphthalenesulfonate; a maleimide monomer such as N-cyclohexylmaleimide, N-isopropylmaleimide, N-laurylmaleimide, and N-phenylmaleimide; an itaconimide monomer such as N-methylitaconimide, N-ethylitaconimide, N-butylitaconimide, N-octylitaconimide, N-2-ethylhexylitaconimide, N-cyclohexylitaconimide, and N-laurylitaconimide; a succinimide monomer such as N-(meth)acryloyloxymethylenesuccinimide, N-(meth)acryloyl-6-oxyhexamethylenesuccinimide, and N-(meth)acryloyl-8-oxyoctamethylenesuccinimide; and a glycol acrylic ester monomer such as polyethyleneglycol (meth)acrylate, polypropyleneglycol (meth)acrylate, methoxyethyleneglycol (meth)acrylate, methoxypropyleneglycol (meth)acrylate, methoxypolyethyleneglycol (meth)acrylate, and methoxypolypropyleneglycol (meth)acrylate. Preferably, a carboxyl group-containing monomer is used.

Examples of the polyfunctional unsaturated monomer include (mono- or poly) alkyleneglycol di(meth)acrylate such as (mono- or poly-) ethyleneglycol di(meth)acrylate such as ethyleneglycol di(meth)acrylate, diethyleneglycol di(meth)acrylate, triethyleneglycol di(meth)acrylate, trimethylolpropane tri(meth)acrylate, and tetraethyleneglycol di(meth)acrylate and (mono- or poly-) propyleneglycol di(meth)acrylate such as propyleneglycol di(meth)acrylate. In addition to the above-described examples, examples of the polyfunctional unsaturated monomer include (meth)acrylic acid ester monomer of polyhydric alcohol such as neopentylglycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate and divinylbenzene. As the polyfunctional unsaturated monomer, epoxyacrylate, polyesteracrylate, and urethaneacrylate are also used.

The polyfunctional unsaturated monomer is not blended when the monomer composition is prepared and can be separately blended in the monomer composition after the monomer composition is prepared.

An example of the monomer includes a copolymerizable unsaturated monomer which is copolymerizable with the above-described monomer.

Examples of the copoymerizable unsaturated monomer include an aromatic vinyl monomer such as styrene and vinyl toluene; (meth)acrylic acid alicyclic hydrocarbon ester such as cyclopentyl di(meth)acrylate, cyclohexyl (meth)acrylate, bornyl (meth)acrylate, and isobornyl (meth)acrylate; aryl (meth)acrylate such as phenyl (meth)acrylate; an alkoxy group-containing unsaturated monomer such as methoxyethyl (meth)acrylate and ethoxyethyl (meth)acrylate; an olefin monomer such as ethylene, propylene, isoprene, butadiene, and isobutylene; a vinyl ether monomer such as vinyl ether; and a halogen atom-containing unsaturated monomer such as vinyl chloride. In addition to the above-described examples, examples of the copoymerizable unsaturated monomer include a vinyl group-containing heterocyclic compound such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, and tetrahydrofurfuryl (meth)acrylate and an acrylic acid ester monomer which contains a halogen atom including a fluorine atom such as fluorine (meth)acrylate. The copolymerizable unsaturated monomers can be used alone or in combination of two or more.

A method for polymerizing the monomer is not particularly limited. Examples thereof include photo polymerization and thermal polymerization. Preferably, in view of being capable of shortening polymerization time, photo polymerization is used.

In order to polymerize the monomer, a known polymerization initiator may be blended in the monomer. For example, when the monomer is polymerized by the photo polymerization, a photo polymerization initiator is blended in the monomer.

Examples of the photo polymerization initiator include a benzoin ether photo polymerization initiator, an acetophenone photo polymerization initiator, an α-ketol photo polymerization initiator, an aromatic sulfonyl chloride photo polymerization initiator, a photoactive oxime photo polymerization initiator, a benzoin photo polymerization initiator, a benzyl photo polymerization initiator, a benzophenone photo polymerization initiator, and a thioxanthone photo polymerization initiator.

To be specific, examples of the benzoin ether photo polymerization initiator include benzoin methyl ether, benzoin ethyl ether, benzoin propyl ether, benzoin isopropyl ether, benzoin isobutyl ether, 2,2-dimethoxy-1,2-diphenylethane-1-one, and anisole methyl ether.

Examples of the acetophenone photo polymerization initiator include 2,2-diethoxyacetophenone, 2,2-dimethoxy-2-phenylacetophenone, 1-hydroxycyclohexylphenylketone, 4-phenoxydichloroacetophenone, and 4-(t-butyl)dichloroacetophenone.

Examples of the α-ketol photo polymerization initiator include 2-methyl-2-hydroxypropiophenone and 1-[4-(2-hydroxyethyl)phenyl]-2-methylpropane-1-one.

An example of the aromatic sulfonyl chloride photo polymerization initiator includes 2-naphthalene sulfonyl chloride.

An example of the photoactive oxime photo polymerization initiator includes 1-phenyl-1,1 -propanedione-2-(o-ethoxycarbonyl)-oxime.

An example of the benzoin photo polymerization initiator includes benzoin.

An example of the benzyl photo polymerization initiator includes benzyl.

Examples of the benzophenone photo polymerization initiator include benzophenone, benzoylbenzoic acid, 3,3′-dimethyl-4-methoxybenzophenone, polyvinylbenzophenone, α-hydroxycyclohexylphenylketone.

Examples of the thioxanthone photo polymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The polymerization initiators can be used alone or in combination of two or more.

The mixing ratio of the polymerization initiator with respect to 100 parts by mass of the monomer is, for example, 0.01 to 5 parts by mass, or preferably 0.05 to 3 parts by mass.

In the photo polymerization, the irradiating light is applied to the monomer so as to partially polymerize the monomer, so that a monomer composition is obtained. Examples of the irradiating light include visible light, ultraviolet light, and electron beam (for example, X-ray, alpha ray, beta ray, gamma ray, and the like). Preferably, ultraviolet light is used.

The rate of polymerization of the obtained monomer composition is, for example, 1 to 20%, or preferably 2 to 10%.

The viscosity (at 25° C.) of the obtained monomer composition is, for example, 0.1 to 100 Pa·s, or preferably 1 to 50 Pa·s.

The weight average molecular weight (Mw) of the obtained monomer composition is, for example, 100000 to 10000000, or preferably 500000 to 9000000.

Next, the above-described thermal conductive particles 3 are blended in 100 parts by mass of the obtained monomer composition at a mixing ratio of, for example, 30 to 400 parts by mass, or preferably 50 to 300 parts by mass and the above-described polyfunctional unsaturated monomer is blended therein at a mixing ratio of, for example, 0.01 to 2 parts by mass, or preferably 0.02 to 1 parts by mass as required to be uniformly mixed, so that a particle-containing monomer mixture is prepared.

Next, in this method, a resin layer 4 made from the above-described resin (ref: FIG. 2 (b)) is separately fabricated.

In order to fabricate the resin layer 4, for example, the above-described monomer composition is applied onto a substrate 5 (ref: FIG. 2 (b)) which is subjected to a release treatment and made of a PET film and the like so as to react the monomer composition by application of light such as ultraviolet light and/or by heating, so that the resin layer 4 is obtained.

The resin layer 4 is not particularly limited as long as it is obtained by reacting the above-described monomer. Preferably, the resin layer 4 is obtained from the same monomer composition as that blended in the preparation of the particle-containing monomer mixture. When the resin layer 4 is fabricated from the monomer composition, the monomer can be easily absorbed in the resin layer 4.

The thickness of the resin layer 4 is, for example, 5 to 5000 μm.

Next, in this method, a particle-containing monomer mixture film 7, as a particle-containing monomer mixture layer, is laminated on the resin layer 4.

A method for laminating the particle-containing monomer mixture film 7 is not particularly limited. For example, first, as shown in FIG. 2 (a), the particle-containing monomer mixture is applied to the top surface of a cover film 6 which is subjected to a release treatment and made of a resin such as PET to form the particle-containing monomer mixture film 7 on the cover film 6.

Next, as shown in FIG. 2 (b), the particle-containing monomer mixture film 7 is attached to the resin layer 4 to be laminated.

The particle-containing monomer mixture film 7 is not fabricated in advance and the particle-containing monomer mixture is directly applied to the top surface of the resin layer 4 by, for example, a known method such as a brush coating, a spray coating, or the like, so that the particle-containing monomer mixture film 7 and the resin layer 4 can be also laminated.

Next, in this method, as shown in FIG. 2 (c), the monomer in the particle-containing monomer mixture is allowed to penetrate into the resin layer 4 to swell the resin layer 4.

In order to allow the monomer in the particle-containing monomer mixture to penetrate into the resin layer 4, the particle-containing monomer mixture is applied onto the resin layer 4 to be then allowed to stand at 20 to 200° C., or preferably 40 to 100° C., for, for example, 0.5 to 60 minutes, or preferably 1 to 30 minutes.

Next, in this method, as shown in FIG. 2 (d), the monomers (including both the monomer which has penetrated into the resin layer 4 and the monomer which does not penetrate into the resin layer 4) in the particle-containing monomer mixture are polymerized to fabricate a particle-localized sheet 8.

An example of the method for polymerizing the monomers in the particle-containing monomer mixture includes, as described above, a method such as photo polymerization and thermal polymerization.

In the case of the photo polymerization, the ultraviolet light is applied at an illuminance of, for example, 1 to 30 mW/cm², or preferably 3 to 20 mW/cm², for, for example, 1 to 20 minutes, or preferably 2 to 10 minutes.

The thickness of the obtained particle-localized sheet 8 is, for example, 10 to 10000 μm.

In the obtained particle-localized sheet 8, the thermal conductive particles 3 are contained at a ratio of, for example, 5 to 60 volume %, or preferably 10 to 50 volume %.

In the particle-localized sheet 8, for example, 90 mass % or more, or preferably 95 to 100 mass % of the total amount of the thermal conductive particles 3 exist within a range of, for example, 5 to 80%, preferably 75% or less of the upper limit, or more preferably 70% or less of the upper limit from one side surface of the particle-localized sheet 8 in defining the length from one side surface to the other side surface of the particle-localized sheet 8 as 100%.

In the following, the area where the thermal conductive particles 3 localize in this way is defined as the particle filled layer 2.

The thickness of the particle filled layer 2 is, for example, 5 to 5000 μm, or preferably 10 to 4000 μm.

Next, in this method, as shown in FIG. 3 (a), a plurality of the particle-localized sheets 8 are laminated. The substrates 5 and the cover films 6 of the particle-localized sheets 8 are peeled off before the lamination of the particle-localized sheets 8.

In order to laminate the particle-localized sheets 8, they are laminated so that one surface thereof in the thickness direction (the surface at the side on which the particle-containing monomer mixture film 7 is laminated) is in contact with the other surface thereof in the thickness direction. In this way, a particle-localized sheet laminate 9 in a generally rectangular column shape in which a plurality of the particle-localized sheets 8 are laminated is formed.

The particle-localized sheet laminate 9 is formed by laminating the particle-localized sheets 8 by, for example, 10 pieces or more, preferably 100 pieces or more, or more preferably 1000 pieces or more. The number of laminated pieces of the particle-localized sheets 8 is not particularly limited and is, for example, 10000 pieces or less, or preferably 5000 pieces or less.

In the particle-localized sheet laminate 9, the particle filled layers 2 are periodically spaced apart from each other at an interval of, for example, 5 to 10000 μm, or preferably 10 to 5000 μm along the laminating direction of the particle-localized sheet 8.

The thickness of the particle-localized sheet laminate 9 in the laminating direction of the particle-localized sheet 8 is, for example, 1 to 100 cm, or preferably 5 to 50 cm.

Next, in this method, as shown in FIG. 3 (b), the particle-localized sheet laminate 9 is cut into a sheet shape along the laminating direction of each of the particle-localized sheets 8. In this way, the thermal conductive sheet 1 is obtained.

The thickness of the obtained thermal conductive sheet 1 is, for example, 5 to 10000 μm, or preferably 10 to 5000 μm.

The particle filled layer 2 in the thermal conductive sheet 1 is formed to have a length in the plane direction of the thermal conductive sheet 1 to be, for example, 5 to 5000 μm, or preferably 10 to 4000 μm. The particle filled layers 2 in the thermal conductive sheet 1 are periodically spaced apart from each other at an interval of, for example, 5 to 10000 μm, or preferably 10 to 5000 μm along the plane direction of the thermal conductive sheet 1.

In the thermal conductive sheet 1, the thermal conductive particles 3 are contained at a ratio of, for example, 5 to 60 volume %, or preferably 10 to 50 volume %.

The thermal conductivity in the thickness direction of the thermal conductive sheet 1 is, for example, 0.5 to 100 W/mK, or preferably 1 to 50 W/mK.

The thermal conductivity of the thermal conductive sheet 1 is measured with a thermal constant measuring device which uses a laser flash method.

According to the method for producing the thermal conductive sheet 1, first, as shown in FIG. 2, the particle-localized sheet 8 in which the thermal conductive particles 3 are localized at one side in the thickness direction thereof is fabricated.

Therefore, in the particle-localized sheet 8, the heat dissipating properties can be improved at one side surface in the thickness direction in which the thermal conductive particles 3 are localized.

As shown in FIG. 3 (a), a plurality of the particle-localized sheets 8 are laminated so as to allow one surface thereof in the thickness direction to be in contact with the other surface thereof in the thickness direction, so that the particle-localized sheet laminate 9 is fabricated.

That is, in the particle-localized sheet laminate 9, the thermal conductive particles 3 are periodically localized in the laminating direction of the particle-localized sheet 8 and are filled in a direction perpendicular to the laminating direction.

Thereafter, as shown in FIG. 3 (b), the particle-localized sheet laminate 9 is cut into a sheet shape along the laminating direction, so that the thermal conductive sheet 1 extending along the laminating direction is formed.

Therefore, in the thermal conductive sheet 1, the thermal conductive particles 3 are periodically localized in the plane direction (the direction in which the thermal conductive sheet 1 extends) and are filled in the thickness direction (the direction perpendicular to the plane direction).

As a result, the thermal conductive particles 3 are filled in the thickness direction and are periodically localized along the plane direction without increasing the used amount of the thermal conductive particles 3, so that the thermal conductivity in the thickness direction can be improved.

According to the method for producing the thermal conductive sheet 1, the particle-containing monomer mixture film 7 is laminated on the resin layer 4, the resin layer 4 absorbs the monomer in the particle-containing monomer mixture, and then, the monomer is polymerized. In this way, the particle-localized sheet 8 is fabricated.

Therefore, in the particle-localized sheet 8, both the monomer which has been absorbed in the resin layer 4 and the monomer which is not absorbed in the resin layer 4 are cured, so that the particle filled layer 2 and the resin layer 4 can be continuously and integrally formed with each other. Therefore, the connecting strength of the particle filled layer 2 to the resin layer 4 can be improved.

As a result, the strength of the particle-localized sheet 8 can be improved and furthermore, the strength of the thermal conductive sheet 1 can be improved.

In the above-described embodiment, an acrylic resin is used as the resin for forming the thermal conductive sheet 1. Alternatively, for example, an epoxy resin is used.

When the epoxy resin is used as the resin, first, for example, the thermal conductive particles 3 and a curing agent are blended and mixed in the epoxy resin such as glycidyl ether epoxide, glycidyl ester epoxide, glycidyl amine epoxide, and alicyclic epoxide to be heated, so that the mixture is brought into a B-stage resin. The obtained B-stage resin, as a particle-containing monomer mixture layer, is laminated on the resin layer 4.

Thereafter, the B-stage resin is heated to be softened and then allowed to stand as it is for, for example, 0.5 to 60 minutes, or preferably 1 to 30 minutes, so that the resin layer 4 swells. Then, the B-stage resin is cured by further heating, so that the particle-localized sheet 8 is fabricated.

Thereafter, in the same manner as in the above-described embodiment, a plurality of the particle-localized sheets 8 are laminated to be then cut into a sheet shape along the laminating direction thereof, so that the thermal conductive sheet 1 is obtained.

In the above-described embodiment, the particle-containing monomer mixture is applied to a separator 6 to form the particle-containing monomer mixture film 7 and then, the particle-containing monomer mixture film 7 is laminated on the resin layer 4. Alternatively, for example, the particle-containing monomer mixture can be directly applied onto the resin layer 4 to form the particle-containing monomer mixture film 7 on the resin layer 4.

In the above-described embodiment, each of the particle-localized sheets 8 is laminated so that one surface thereof in the thickness direction (the surface at the side on which the particle-containing monomer mixture film 7 is laminated) is in contact with the other surface thereof in the thickness direction. In this way, the particle-localized sheet laminate 9 in a generally rectangular column shape is formed. However, the lamination of the particle-containing monomer mixture films 7 is not particularly limited. For example, a portion in which one surfaces in the thickness direction are laminated so as to be in contact with each other and a portion in which the other surfaces in the thickness direction are laminated so as to be in contact with each other can be mixed.

In the above-described embodiment, the length in the plane direction of each of the particle filled layers 2 and that of each of the resin layers 4 in the thermal conductive sheet 1 are formed to be constant and each of the particle filled layers 2 is periodically arranged. However, the length in the plane direction of each of the particle filled layers 2 and that of each of the resin layers 4 may not be constant and each of the particle filled layers 2 can be non-periodically arranged.

The thermal conductive sheet 1 obtained in this way can be preferably used, for example, as a thermal conductive sheet used in power electronics technology, to be more specific, as a thermal conductive sheet used in an LED heat dissipating board and a heat dissipating material for a battery.

### EXAMPLES

While the present invention will be described hereinafter in further detail with reference to Example and Comparative Example, the present invention is not limited to these Example and Comparative Example.

### Example

### 1. Preparation of Particle-Containing Monomer Mixture

### (1) Preparation of Monomer Composition

As a monomer, 90 parts by mass of 2-ethylhexylacrylate and 10 parts by mass of acrylic acid were charged in a four-necked separable flask provided with a mixer, a thermometer, a nitrogen gas introducing tube, and a cooling tube to be mixed.

Next, 0.1 parts by mass of a photo polymerization initiator (IRGACURE 651, 2,2-dimethoxy-1,2-diphenylethane-1-one, manufactured by Ciba Specialty Chemicals Inc.) was charged and stirred to be uniformly mixed and then, was subjected to a bubbling process while being stirred for 1 hour using a nitrogen gas, so that dissolved oxygen was removed.

Thereafter, while the stirring and the nitrogen bubbling continued, ultraviolet light was applied to the obtained mixture from the outside of the separable flask using a black light lamp to be polymerized, so that a monomer composition which had the rate of polymerization of 7%, the viscosity (at 25° C.) of 10 Pa·s, and the weight average molecular weight (Mw) of 5000000 was prepared.

### (2) Preparation of Particle-Containing Monomer Mixture

50 parts by mass of a boron nitride particle (an average particle size of 9 μm, UHP-1, manufactured by Showa Denko K.K.) and 0.1 parts by mass of 1,6-hexanedioldiacrylate were uniformly mixed in 100 parts by mass of the obtained monomer composition to prepare a particle-containing monomer mixture.

### 2. Fabrication of Resin Layer

The monomer composition was applied onto a biaxially oriented polyethylene terephthalate film having a thickness of 38 μm and then, a protecting film was attached onto the applied film so that its surface which was subjected to a release treatment came into contact with the monomer composition.

Thereafter, the monomer composition was cured by applying ultraviolet light thereto at an illuminance of 5 mW/cm² for 3 minutes using a black light lamp, so that a resin layer covered with the protecting film and having a thickness of 100 μm was formed on the biaxially oriented polyethylene terephthalate film.

### 3. Fabrication of Thermal Conductive Sheet

### (1) Fabrication of Particle-Localized Sheet

The particle-containing monomer mixture was applied to the surface which was subjected to a release treatment of a cover film, so that a particle-containing monomer mixture film was formed on the cover film (ref: FIG. 2 (a)).

Separately, the protecting film was peeled from the resin layer to expose the resin layer.

The particle-containing monomer mixture film was attached to the resin layer to be laminated (ref: FIG. 2 (b)).

After the particle-containing monomer mixture film was laminated on the resin layer, the laminated layer was allowed to stand for 1 minute and the monomer in the particle-containing monomer mixture was allowed to penetrate into the resin layer, so that the resin layer swelled (ref: FIG. 2 (c)).

Thereafter, the particle-containing monomer mixture was cured by applying ultraviolet light thereto from the particle-containing monomer mixture film side at an illuminance of 5 mW/cm² for 3 minutes using a black light lamp, so that a particle-localized sheet having a thickness of 250 μm was fabricated (ref: FIG. 2 (d)).

In the particle-localized sheet, 95 mass % of the total amount of the thermal conductive particles existed within a range of 60% from one side surface in the thickness direction of the particle-localized sheet (a particle filled layer) in defining the thickness of the obtained particle-localized sheet as 100%.

In the obtained particle-localized sheet, the thickness of the particle filled layer was 150 μm.

(2) Fabrication of Thermal Conductive Sheet The particle-localized sheets were prepared, and the cover film and the biaxially oriented polyethylene terephthalate film of each of the particle-localized sheets were peeled off. The particle-localized sheets were laminated so as to allow one surface (the surface at the side on which the particle-containing monomer mixture film was applied) thereof to be in contact with the other surface thereof, so that a particle-localized sheet laminate was fabricated (ref: FIG. 3 (a)).

The thickness of the particle-localized sheet laminate in the laminating direction of the particle-localized sheet was 2 cm.

Next, the particle-localized sheet laminate was cut into a sheet shape along the laminating direction of each of the particle-localized sheets, so that a thermal conductive sheet having a thickness of 500 μm was obtained (ref: FIG. 3 (b)).

The particle filled layer in the thermal conductive sheet was formed to have a length in the plane direction of the thennal conductive sheet to be 150 μm. The particle filled layers in the thermal conductive sheet were periodically spaced apart from each other at an interval of 100 μm along the plane direction of the thermal conductive sheet.

### Comparative Example

### 1. Preparation of Particle-Containing Monomer Mixture

12.5 parts by mass of a boron nitride particle (an average particle size of 9 μm, UHP-1, manufactured by Showa Denko K.K.) and 0.1 parts by mass of 1,6-hexanedioldiacrylate were uniformly mixed in 87.4 parts by mass of the same monomer composition as that in Example 1 to prepare a particle-containing monomer mixture.

### 2. Fabrication of Thermal Conductive Sheet

The particle-containing monomer mixture was applied onto a biaxially oriented polyethylene terephthalate film having a thickness of 38 μm and then, a protecting film was attached onto the applied film so that its surface which was subjected to a release treatment came into contact with the particle-containing monomer mixture.

Thereafter, the particle-containing monomer mixture was cured by applying ultraviolet light thereto at an illuminance of 5 mW/cm² for 3 minutes using a black light lamp, so that a thermal conductive sheet covered with a protecting film and having a thickness of 500 μm was formed on the biaxially oriented polyethylene terephthalate film.

### Measurement of Thermal Conductivity

The thermal conductivity in the thickness direction of the thermal conductive sheets in Example and Comparative Example was measured with a laser flash method thermal constant measuring device (TC-9000, manufactured by ULVAC-RIKO, Inc.).

The thermal conductivity of the thermal conductive sheet in Example was 2.1 W/mK and that of the thermal conductive sheet in Comparative Example was 0.4 W/mK.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A thermal conductive sheet obtained by
preparing a resin layer;
laminating a particle-containing monomer mixture layer which contains a monomer to be absorbed in the resin layer and a thermal conductive particle on one side surface of the resin layer;
localizing the thermal conductive particle at one surface side by allowing the monomer to be absorbed in the resin layer; thereafter,
reacting the monomer to be cured so as to fabricate a particle-localized sheet;
laminating a plurality of the particle-localized sheets so as to allow one surface thereof to be in contact with the other surface thereof to fabricate a particle-localized sheet laminate; and then,
cutting the particle-localized sheet laminate into a sheet shape along a laminating direction of each of the particle-localized sheets.

2. A method for producing a thermal conductive sheet comprising the steps of:
preparing a resin layer,
laminating a particle-containing monomer mixture layer which contains a monomer to be absorbed in the resin layer and a thermal conductive particle on one side surface of the resin layer,
localizing the thermal conductive particle at one surface side by allowing the monomer to be absorbed in the resin layer,
fabricating a particle-localized sheet by reacting the monomer to be cured,
laminating a plurality of the particle-localized sheets so as to allow one surface thereof to be in contact with the other surface thereof to fabricate a particle-localized sheet laminate, and
cutting the particle-localized sheet laminate into a sheet shape along a laminating direction of each of the particle-localized sheets.
